(19) United States
(12) Patent Application Publication
(10) Pub. No.: US 2009/0271867 A1
(43) Pub. Date: Oct. 29, 2009

(54) Virtual machine to detect malicious code

(76) Inventor: Peng Zhang, Shanghai (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/583,051

(22) PCT Filed: Dec. 30, 2005
(86) PCT No.: PCT/CN2005/002386

§ 371 Date: Jun. 14, 2006

(51) Int. Cl. G06F 12/14; G06F 17/30; G06F 12/00; G06F 12/08

(52) U.S. Cl. 726/24; 707/3; 711/6; 711/163; 711/125; 711/E12.001; 711/E12.091; 711/E12.02

(57) ABSTRACT

One embodiment of the invention discloses a method for receiving in a virtual machine (VM) contents of a program for creating a virtual environment for interacting with a host platform in a computing device; and determining by the VM if the received contents comprise predetermined instructions for performing at least one unauthorized task. Another embodiment of the invention discloses a method for receiving a system call for a host platform in communication with a VM of a computing device; and determining by the VM if the received system call comprises at least one predetermined system call for performing at least one unauthorized task. Yet another embodiment of the invention discloses a method for receiving a virtualized memory address for a host platform in communication with a VM of a computing device; and determining by the VM if the received virtualized memory address comprises at least one predetermined unauthorized virtualized memory address.

### FIELD

Embodiments of the invention relates to virtual machines, and more particularly to detection of malicious code by a virtual machine.

### BACKGROUND

Computer networking is prevalent amongst many users of computing devices, such as personal computers and workstations. Networking allows users of computing devices to communicate with each other in various forms, such as the exchange of data or computer programs which can be downloaded from the network and run on each computing device. A typical network environment, however, includes computing devices which operate on different (and often incompatible) operating systems host platforms, such as Windows®, DOS™, Linux®, etc, thus making it difficult for a downloaded computer program to be directly run on the different computing devices.

One prevalent approach to the foregoing problem is by the use of virtual machine, in a computing device. A virtual machine, such as dynamic binary translator, Just-in-Time compiler, or Java Virtual Machine Interpreter, etc. is an abstract computing device that virtualizes an environment on which a computer program can run on a host platform. In this way, the same computer program can be run on different (and otherwise incompatible) operating systems host platforms. In addition a virtual machine can enable a computer program to run on computers with different architectures.

The use of virtual machines, while effective for running computer programs on different operating systems host platforms, is not without shortcomings in other respects, such as in the area of security. The security issues arise from the added vulnerability of a computing device to malicious code while using the virtual machine. Malicious code, also termed as malware, describes the code fragments intentionally performing an unauthorized process, and which can invade a computing device across the network. Variants of malicious code are virus, worm, Trojan horse, spyware, adware, logic bomb and backdoors. Generally, virtual machines prevent the traditional anti-malware software, which are individual programs, from catching the malicious code running on top of them or the host platform, because in such situations the anti-malware software would not be effective without support from the virtual machine.

One situation in which anti-malware software would not be effective is when the individual anti-malware software runs on top of the host platform. The anti-malware software will then fail to emulate the monitored program's execution before the monitored program really starts. This emulation is necessary to modern anti-malware software because of the emergence of polymorphism viruses. The polymorphism viruses self-encrypt with different decryption routines to produce varied but operational copies of themselves, so polymorphism viruses don't have fixed code patterns in the executable image file. To detect them, the anti-malware software must run the monitored program in an emulated and insulated environment before the program actually starts. During the emulation, the anti-malware software scans virus signatures in the emulated memory. For performance considerations, however, if after a period of time the virus signatures have not been found, the emulation stops and the monitored program then starts. Since the target host platform is determined to the anti-malware software, the anti-malware software prepares a simulator for the host platform before hand. But predicting which virtual machines are going to be installed on the host platform is difficult, thus making it impractical for the individual anti-malware software to prepare simulators for all virtual machines beforehand. In addition, simulating a virtual machine will be too complex to the individual anti-malware software, which degrades the performance to unacceptable levels.

In addition, if the individual anti-malware software runs on top of the host platform, it will fail to intercept the original system calls issued from the interpreter functions and translation cache of virtual machine environment. In this scenario, some anti-malware software intercepts system calls from the monitored program to detect malicious code. The system calls issued from interpreter functions and translation cache, however, were converted by the system call converter before the anti-malware software intercepts them, which will mislead the anti-malware software. Moreover, the individual anti-malware software typically fails to run on most virtual machines because privileged instructions are included in individual anti-malware software but are not supported by most virtual machines.

### BRIEF DESCRIPTION OF THE DRAWINGS

Embodiments of the invention may best be understood by referring to the following description and accompanying drawings that are used to illustrate embodiments of the invention.

FIG. 1 is an exemplary block diagram of computing device in which embodiments of the invention may be practiced.

FIGS. 2A-6 are exemplary flow charts illustrating processes according to an exemplary embodiment of the invention.

FIGS. 7A-B are exemplary flow charts illustrating processes according to another exemplary embodiment of the invention.

FIGS. 8A-B are exemplary flow charts illustrating processes according to yet another exemplary embodiment of the invention.

### DETAILED DESCRIPTION OF THE INVENTION

Embodiments of the invention generally relate to systems and methods for detection of malicious code by a virtual machine. Herein, embodiments of the invention may be applicable to virtual machines used in a variety of computing devices, which are generally considered stationary or portable electronic devices. Examples of computing devices include any type of stationary or portable electronic device that may be adversely effected by malware such as a computer, work station, a set-top box, a wireless telephone, a digital video recorder (DVR), networking equipment (e.g., routers, servers, etc.) and the like.

Certain details are set forth below in order to provide a thorough understanding of various embodiments of the invention, albeit embodiments of the invention may be practiced through many embodiments of the invention other than those illustrated. Well-known logic and operations are not set forth in detail in order to avoid unnecessarily obscuring this description.

In the following description, certain terminology is used to describe features of the various embodiments of the invention. The term “software” generally denotes executable code such as an operating system, an application, an applet, a routine or even one or more instructions. The software may be stored in any type of memory, namely suitable storage medium such as a programmable electronic circuit, a semiconductor memory device, a volatile memory (e.g., random access memory, etc.), a non-volatile memory (e.g., read-only memory, flash memory, etc.), a floppy diskette, an optical disk (e.g., compact disk or digital versatile disc “DVD”), a hard drive disk, tape, or any kind of interconnect.

In general terms, a virtual machine (also known as software dynamic translator) creates an environment between a host platform on a computer and an end-user, in which the end user can operate software otherwise incompatible with the host platform. Variants of virtual machine are dynamic binary translator, interpreters, and just-in-time (JIT) compilers. A “host platfrom” is an operating system, such as Windows®, DOS™ and Linux®, which enables a computing device to run various softwares. A malicious code, also termed as “malware”, describes the code fragments intentionally performing unauthorized tasks. Variants of malicious code are virus, worm, Trojan horse, spyware, adware, logic bomb and backdoors. A “translation cache” describes reusable translated code generated by a virtual machine that is unnecessary to exist in processor. An “interpreter” is a program that executes other programs, such as a Java Interpreter executing Java® programs.

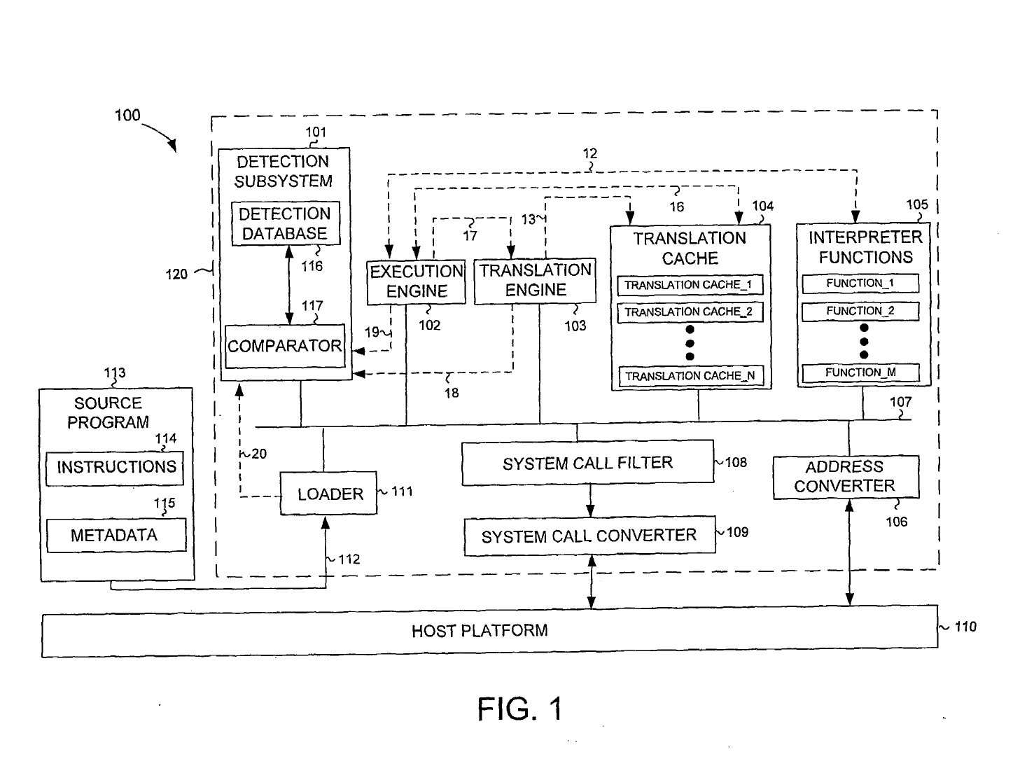

With reference to FIG. 1, a block diagram of a computing device 100 in which embodiments of the invention may be practiced is shown. As shown in FIG. 1, the computing device 100 includes a virtual machine 120 to receive contents 112 of a source program 113, such as instructions 114 and metadata 115, for creating a virtual environment for interacting with a host platform 110 in the computing device 100. The virtual machine 120 comprises a detection subsystem 101 to determine if the received contents 112 comprises predetermined instructions for performing unauthorized tasks, such as malware instructions as defined above. The virtual machine 120 is then to purge the predetermined instructions from at least one of the source program 113 or the received contents 112 of the source program 113.

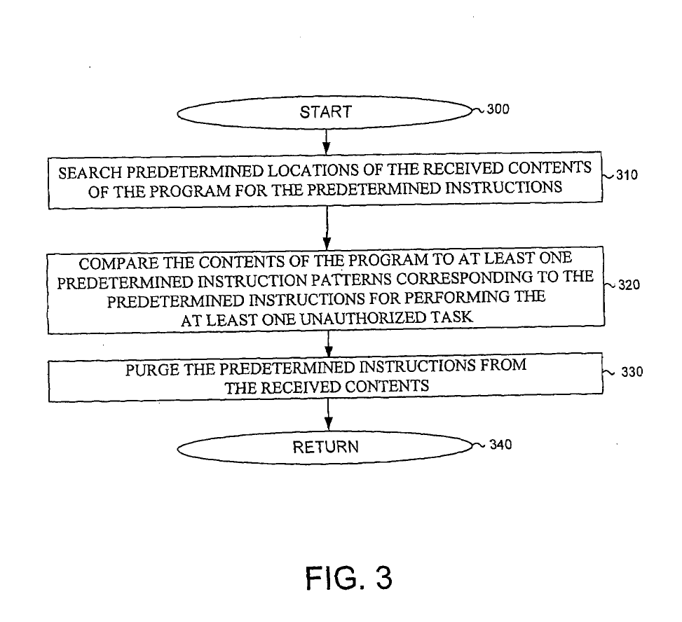

The detection subsystem 101 further comprises a comparator logic 117 to compare the received contents 112 to at least one predetermined instruction pattern stored in a detection database 116, which corresponds to the predetermined instructions for performing unauthorized tasks. The detection database 116 may be external to the detection subsystem 101 or the virtual machine 120. Suitably, the comparator logic 117 includes a search logic (not shown) to first search predetermined locations of the contents 112 for the predetermined instructions for performing unauthorized tasks, as described below and in greater detail in conjunction with FIG. 3. The comparator logic 117 may be implemented in hardware or software stored on a memory storage medium (not shown).

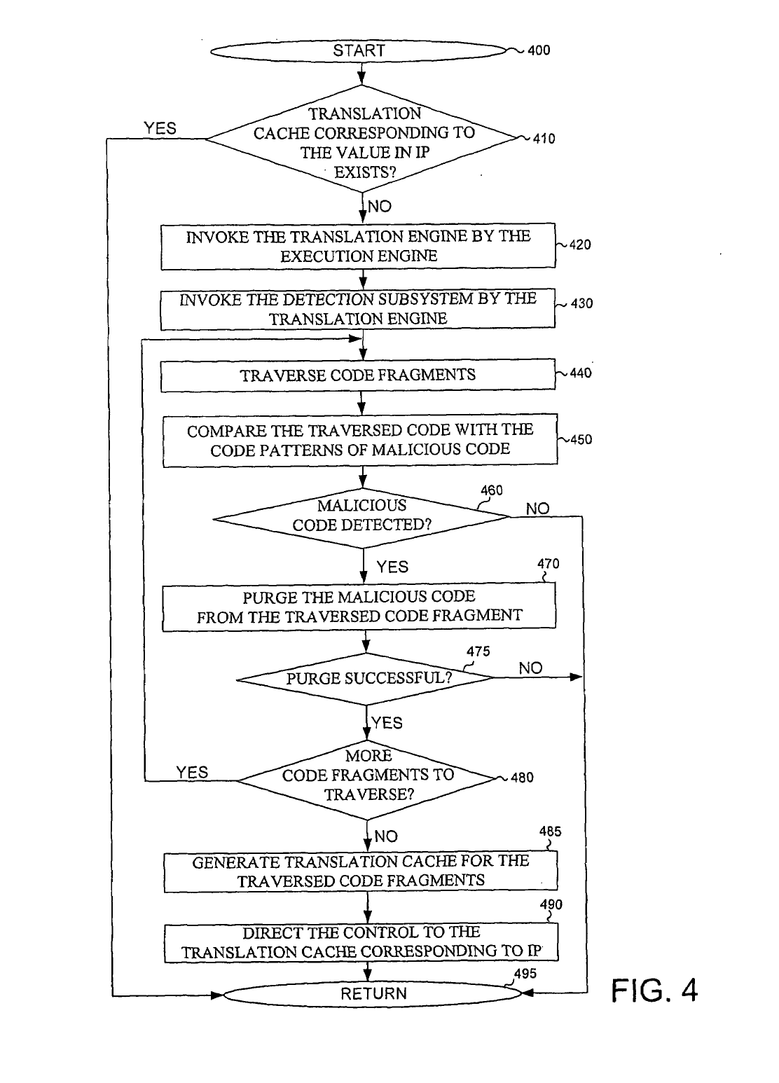

As also shown in FIG. 1, the virtual machine 120 further comprises at least one translation cache 104, such as translation cache_1 through translation cache N (N≧1). The virtual machine 120 also includes a translation engine 103 to invoke the detection subsystem 101 to determine if the instructions 114 in the source program 113 comprises predetermined instructions for performing unauthorized tasks, as described below and in greater detail in conjunction with FIG. 4. The virtual machine 120 also includes a loader 111 to receive contents 112 of the source program 113 and to invoke the detection subsystem 101.

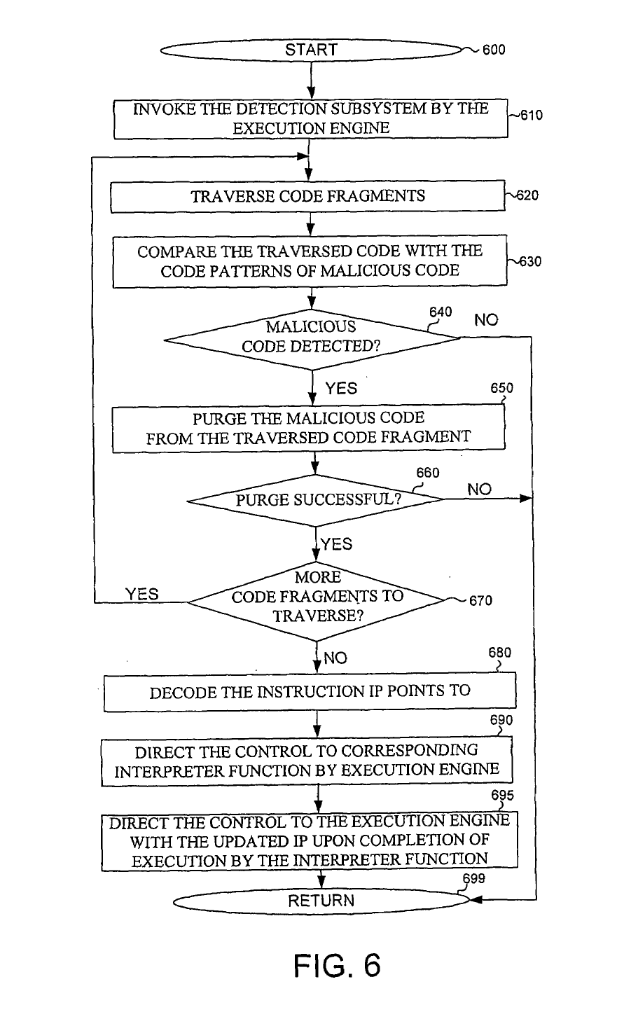

The virtual machine 120 may also include interpreter functions 105, such as function_1 through function M (M>1), and an execution engine 102 to invoke the detection subsystem 101 to determine if the instructions 114 in the source program 113 that may include predetermined instructions for performing unauthorized tasks prior to invoking the interpreter functions 105, as described below and in greater detail in conjunction with FIG. 6. It should be noted that interpreter functions 105, translation engine 103 and translation cache 104 are implementation dependent, so that an exemplary virtual machine 120 may have only the interpreter function 105 feature (such as in a Java interpreter implementation), or only the translation engine 103 and translation cache 104 feature (such as in a Java Just-In-Time (JIT) compiler implementation), or both features. Typically, an interpreter function 105 simulates an instruction from the source program 113 and is prepared at the build time, whereas a piece of translation cache 104 is able to simulate a number of instructions and is generated by the translation engine 103 at runtime.

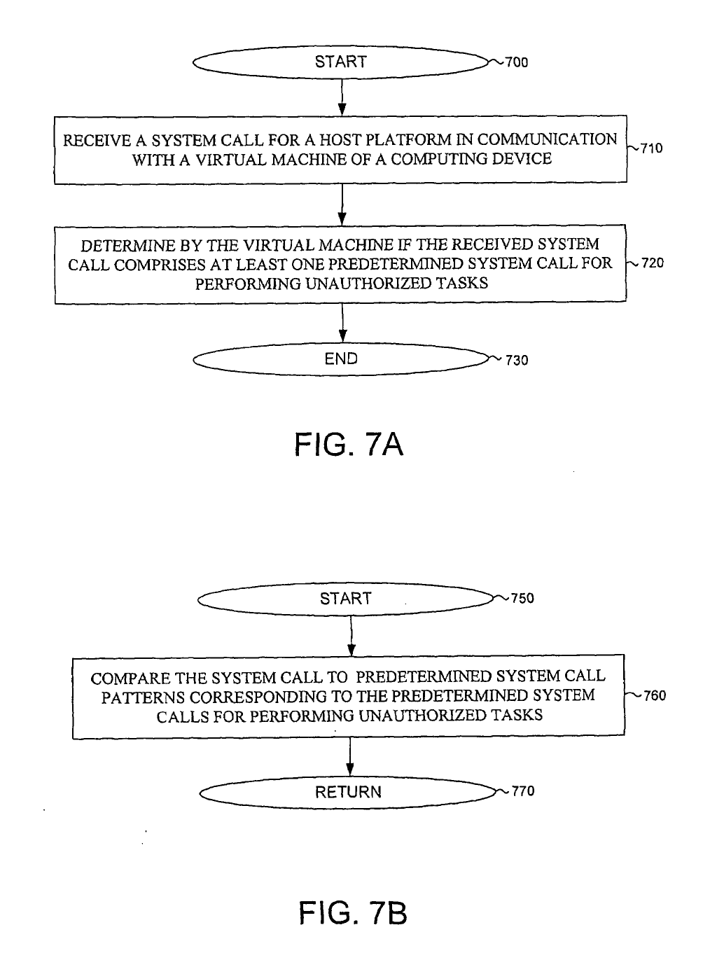

Interpreter functions 105 and translation cache 104 use the services provided by the address converter 106 and system call converter 109. The address converter 106 converts received virtualized memory addresses, which are used by interpreter functions 105 and translation cache 104, into memory addresses meaningful to the host platform 110 before the memory accesses really happens. The system call converter 109 converts system calls issued from interpreter functions 105 and translation cache 104 into the meaningful system calls to the host platform 110. In an embodiment of the invention, a system call filter 108 is implemented to filter out system calls for performing unauthorized tasks, as described below and in greater detail in conjunction with FIGS. 7A-7B. Suitably, communications between the execution engine 102, translation engine 103, translation cache 104, interpreter functions 105, address converter 106, system call filter 108, loader 111, detection subsystem 101, as well as other components (not shown) of the computing device 100 are enabled via a bus 107.

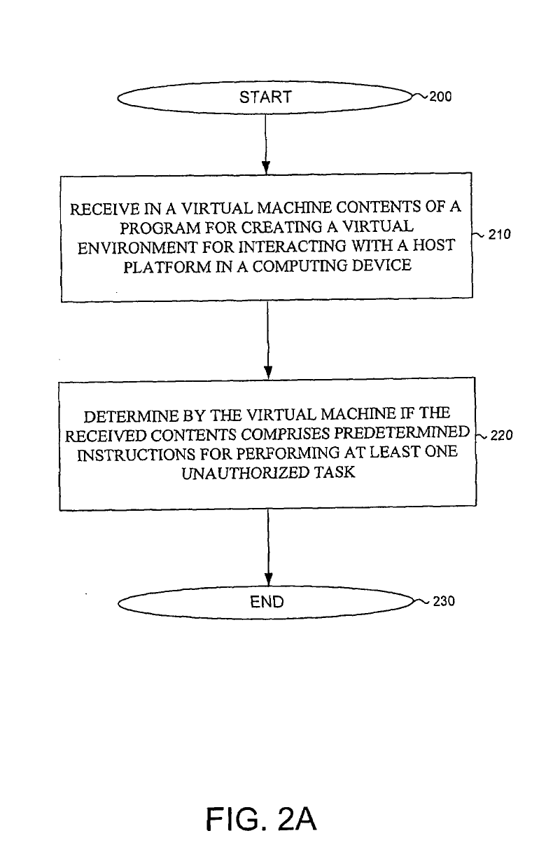

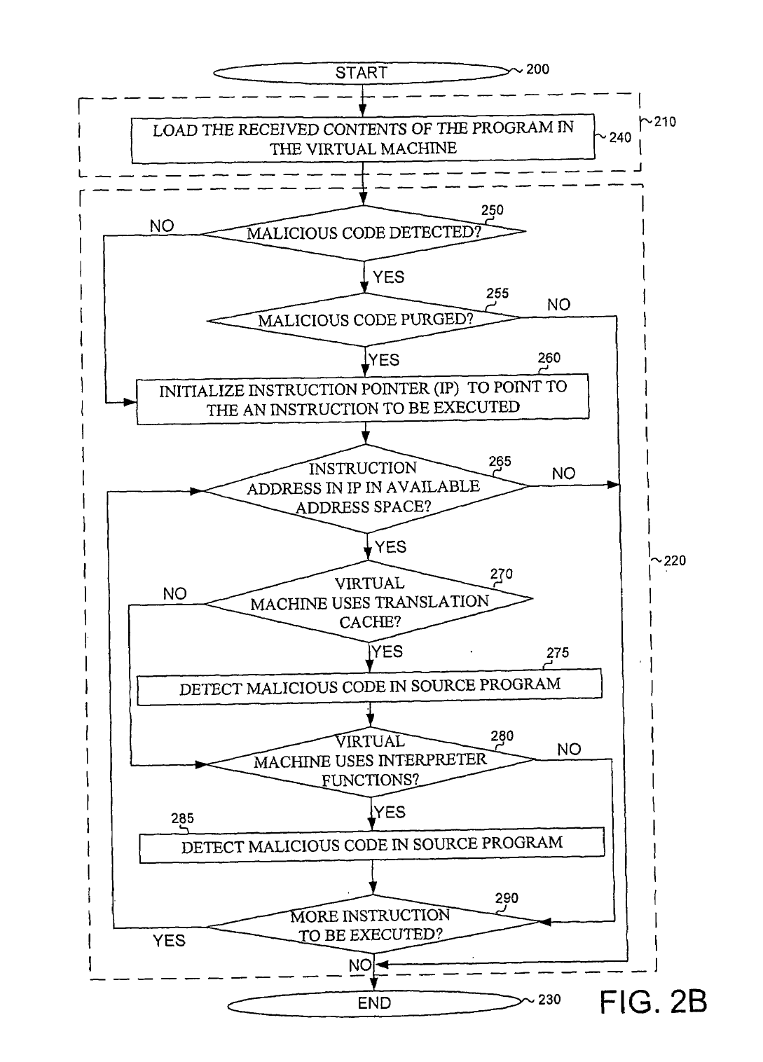

FIG. 2A is an exemplary flow chart illustrating a process according to an exemplary embodiment of the invention. As shown in FIG. 2A (in conjunction with FIG. 1), following the start of the process (block 200), contents 112 of a program are received in the virtual machines 120 for creating a virtual environment for interacting with host platform 110 in the computing device 100 (block 210), as described below and in greater detail in conjunction with FIG. 2B. The virtual machine 120 then determines if the received contents 112 comprises predetermined instructions for performing unauthorized tasks (block 220), as described below and in greater detail in conjunction with FIG. 2B. The overall process then ends (block 230).

FIG. 2B is an exemplary flow chart illustrating the operations of FIG. 2A in conjunction with FIG. 1. As shown in FIG. 2B, following the start of the process (block 200), contents 112 of a program are received in the virtual machines 120 (block 210). In an exemplary embodiment of the invention, the contents 112 are first received in the loader 111 from the source program 113 (block 240), as shown symbolically by line 112 in FIG. 1. Then, the loaded contents 112 are examined for detection of any predetermined instructions for performing unauthorized tasks, such as malicious code (block 250), as described below and in greater detail in conjunction with FIG. 3. If malicious code is detected, attempts are made to purge the malicious code (block 255). If the malicious code cannot be purged, then the overall process ends (block 230). If the no malicious code is detected, or if the detected malicious code is successfully purged (blocks 250, 255), an instruction pointer (IP) is initialized to point to an instruction in the loaded contents 112 to be executed (block 260), such as initializing IP to point to the first instruction in the loaded contents 112.

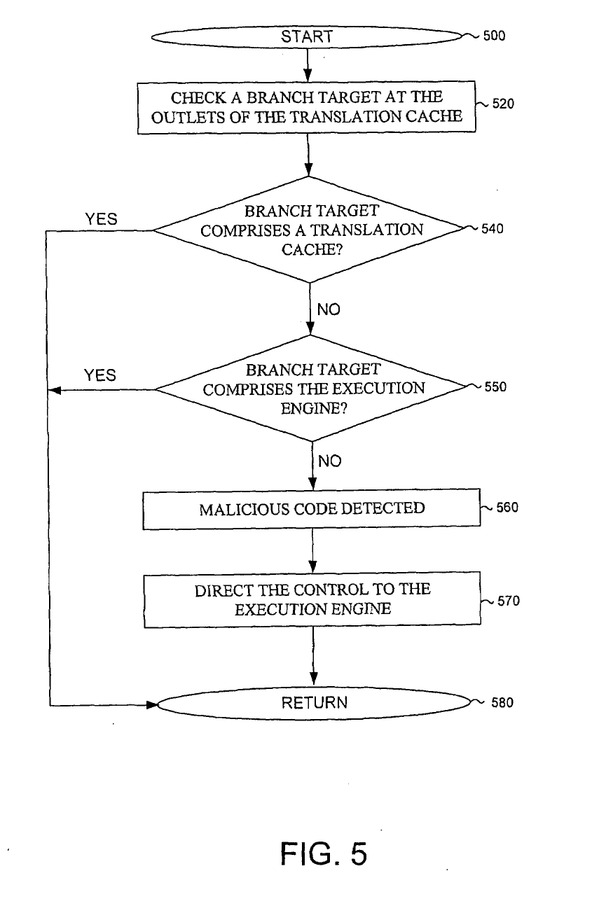

The process then involves a determination of whether the instruction address in IP resides in available address space (block 265). If the instruction address in IP does not reside in available address space, the overall process ends (block 230). Otherwise, it is determined if the virtual machine 120 uses translation cache 104, such as when the virtual machine 120 includes a Java JIT complier (block 270). Next, prior to generating translation cache 104, the instructions 114 in the source program 113 are tested again to determine if they may include malicious code (block 275), as described below and in greater detail in conjunction with FIGS. 4-5. If it is determined the virtual machine 120 does not use translation cache 104, or following completion of detection of malicious code in translation cache 104 (blocks 270, 275), then it is determined if the virtual machine 120 uses interpreter functions 105 of FIG. 1, such as when the virtual machine 120 includes a Java interpreter (block 280). If so, prior to invoking the interpreter functions 105, the instructions 114 in the source program 113 are tested to determine if they may include malicious code (block 285), as described below and in greater detail in conjunction with FIG. 6. Following the operations of block 285, or if the virtual machine 120 uses interpreter functions 105 (block 280), it is determined if more instruction are to be executed (block 290). If so, further processing continues (block 265), and if not, the overall process ends (block 230).

FIG. 3 is an exemplary flow chart which, in conjunction with FIG. 1, further illustrates the detection and purging of the malicious code shown in FIG. 2B (blocks 250, 255). As shown in FIG. 3, following the start of the process (block 300), predetermined locations of the received contents 112 of the program 113 are searched for the malicious code (block 310). In an exemplary embodiment of the invention, the loader 111 invokes the detector subsystem 101, as shown symbolically by line 20 in FIG. 1, for performing the search. The detection subsystem 101 comprises a detection database 116 which contains possible locations in received contents 112 in which malicious code may reside. Next, the contents 112 of the program 113 are compared to predetermined instruction patterns corresponding to the malicious codes which perform unauthorized tasks (block 320). In an exemplary embodiment of the invention, the comparison is performed by the comparator 117 in communication with the detection database 116, which contains predetermined instruction patterns corresponding to the malicious codes. If a match is found, then a malicious code is deemed detected. Following the comparing, the malicious code is purged from the received contents 112 by the detector subsystem (block 330). Suitably, the detection database 116 contains a prescription on how to purge the malicious code from the received contents 112. The flow is then returned to block 255 of FIG. 2B (block 340).

FIG. 4 is an exemplary flow chart which in conjunction with FIG. 1 further illustrates the detection of the malicious code in the instructions 114 of the source program 113 shown in FIG. 2B (block 275). As shown in FIG. 4, following the start of the process (block 400), it is determined if a translation cache 104, such as translation cache_1, corresponding to the value in the instruction pointer (IP) (initialized in block 260 of FIG. 2B) exists (block 410). If so, no malicious code is detected and the flow is returned to block 275 of FIG. 2B (block 495), otherwise, the translation engine 103 is invoked by the execution engine 102 (block 420), as shown symbolically by line 17 in FIG. 1. The translation engine 103 then invokes the detection subsystem 101 (block 430), as shown symbolically by line 18 in FIG. 1.

Next, starting from the instruction that IP points to, the translation engine 103 traverses code fragments in the instructions 114 in the source program 113 (block 440). For each traversed code fragment, the translation engine 103 invokes the detection subsystem 101 to compare the traversed code with the code patterns of malicious code (block 450). If no match is found, then no malicious code is detected and the flow is returned to block 275 of FIG. 2B (blocks 460, 495). If a match is found, malicious code is detected (block 460), in which case the virtual machine 120 attempts to purge the malicious code from the traversed code fragment by following the prescription in the record stored in the detection database 116 (block 470). If the purge was unsuccessful the flow is returned to block 275 of FIG. 2B (blocks 475, 495), the execution operations of the virtual machine 120 is stopped for the loaded contents 112. If the purge was successful, it is determined if more code fragments are to be traversed (block 480) and if so, the process is returned to block 440, otherwise the translation engine 103 generates a translation cache 104, such as translation cache_2, for the traversed code fragments (block 485), as shown symbolically by line 13 in FIG. 1. The execution engine 102 then directs control to the translation cache 104 corresponding to the IP, such as to translation cache_2 (block 490), as shown symbolically by line 16 in FIG. 1.

When the control reaches an outlet of a translation cache 104, the IP has been updated and the translation cache 104 should direct the control back to the execution engine 102, as shown symbolically by line 16 in FIG. 1, or to another translation cache 104. In an exemplary embodiment of the invention, before the control is actually directed back to the execution engine 102 or to another translation cache 104, additional safety measures are undertaken to reduce the occurrence of malicious code directing the control to an unauthorized location, as described below and in greater detail in conjunction with FIG. 5.

FIG. 5 is an exemplary flow chart which in conjunction with FIG. 1 further illustrates the detection of the malicious code in the instructions 114 in the source program 113 prior to generating of the translation cache 104 shown in FIG. 2B (block 275). As shown in FIG. 5, following the start of the process (block 500), a branch target at the outlets of a translation cache 104 is checked (block 520). If the branch target is not a piece of either translation cache 104 or the execution engine 102 (blocks 540, 550), then malicious code is deemed detected (block 560). The control is then directed back to the execution engine 102 (block 570), as shown symbolically by line 16 in FIG. 1, which then stops the execution operations of the virtual machine 120 for the loaded contents 112, following the return of the flow to block 275 of FIG. 2B (block 580). If the branch target is a piece of either translation cache 104 or the execution engine 102 (blocks 540, 550), then malicious code is deemed not detected and the flow is returned to block 275 of FIG. 2B (block 580). Suitably, prior to the operations of FIG. 5, the translation engine 103 generates translation cache logic instructions for performing the foregoing operations described in conjunction with FIG. 5.

FIG. 6 is an exemplary flow chart which in conjunction with FIG. 1 further illustrates the detection of the malicious code in the instructions 114 in the source program 113 prior to invoking of the interpreter functions 105 shown in FIG. 2B (block 285). As shown in FIG. 6, following the start of the process (block 600), the execution engine 102 invokes the detection subsystem 101, as shown symbolically by line 19 in FIG. 1. Next, starting from the instruction that IP points to, the execution engine 102 traverses code fragments instructions 114 in the source program 113 (block 620). For each traversed code fragment, the invoked detection subsystem 101 compares the traversed code with the code patterns of malicious code (block 630). If no match is found, then no malicious code is detected and the flow is returned to block 285 of FIG. 2B (blocks 640, 699). If a match is found, malicious code is detected (block 640), in which case the virtual machine 120 attempts to purge the malicious code from the traversed code fragment by following the prescription in the record stored in the detection database 116 (block 650). If the purge was unsuccessful the flow is returned to block 285 of FIG. 2B (blocks 660, 699), and the execution operations of the virtual machine 120 are stopped for the loaded contents 112. If the purge was successful, it is determined if more code fragments are to be traversed (block 670), and if so, the process is returned to block 620. Otherwise the execution engine 102 decodes the instructions that IP points to (block 680).

Next, the execution engine 102 directs the control to the corresponding interpreter function 105, such as to function_2, as shown symbolically by line 12 in FIG. 1. Upon completion of the execution by the interpreter functions 105, the control is directed back to the execution engine 102 with an updated IP (block 695), as shown symbolically by line 12 in FIG. 1. The flow is then returned to block 285 of FIG. 2B (block 699).

FIGS. 7A-B are exemplary flow charts illustrating processes according to another exemplary embodiment of the invention. As described above in conjunction with FIG. 1, interpreter functions 105 and translation cache 104 use the services provided by the system call converter 109. The system call converter 109 converts system calls issued from interpreter functions 105 and translation cache 104 into the meaningful system calls to the host platform 110. In an exemplary embodiment of the invention, a system call filter 108 is implemented to filter out system calls for performing unauthorized tasks. Exemplary operations of the system call filter 108 is described in conjunction with FIGS. 7A-B.

As shown in FIG. 7A, following the start of the process (block 700), a system call for the host platform 110 is received in the system call filter 108 (block 710), such as via a system call interception. The virtual machine 120 then determines if the received system call contains predetermined system calls for performing unauthorized tasks (block 720), as described in greater detail in conjunction with FIG. 7B below. The overall flow then ends (block 730).

FIG. 7B is an exemplary flow chart which in conjunction with FIG. 1 further illustrates the operations shown in FIG. 7A (block 720) to determine if the received system call comprises predetermined system calls for performing unauthorized tasks. As shown in FIG. 7B, following the start of the process (block 750), the received system call is compared to predetermined system calls patterns corresponding to the predetermined system calls for performing unauthorized tasks (block 760). In an exemplary embodiment of the invention, a system call is determined to be for performing unauthorized tasks if its task is inhibitive, or results in outputting of data into the memory regions storing instructions or data for operations of the virtual machine 120 and its components, including the translation cache 104. If the system call is determined to be unauthorized, malicious code is deemed detected and the operations of the virtual machine 120 corresponding to the system call will be stopped. Otherwise, if the system call is determined to be authorized, the system call filter 108 passes the system call to system call converter 109. The flow is then returned to block 720 of FIG. 7A (block 770).

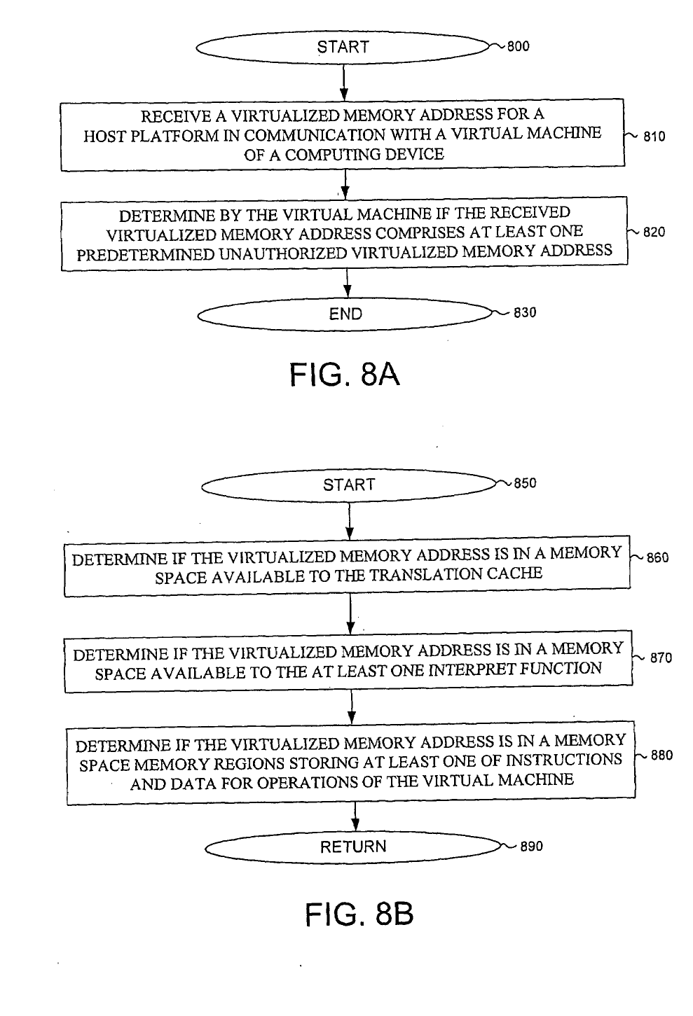

FIGS. 8A-B are exemplary flow charts illustrating processes according to yet another exemplary embodiment of the invention. As described above in conjunction with FIG. 1, interpreter functions 105 and translation cache 104 use the services provided by the address converter 106. The address converter 106 converts received virtualized memory addresses, which are used by interpreter functions 105 and translation cache 104, into memory addresses meaningful to the host platform 110 before the memory accesses really happens. In an exemplary embodiment of the invention, before the address converter 106 converts a received virtualized memory address to a memory address meaningful to the host platform 110, it checks the received virtualized memory address to determines if the received virtualized memory address is an unauthorized virtualized memory address, as described in greater detail in conjunction with FIGS. 8A-B.

As shown in FIG. 8A, following the start of the process (block 800), a virtualized memory address for the host platform 110 is received in the address converter 106 (block 810). The virtual machine 120 then determines if the received virtualized memory address comprises predetermined unauthorized virtualized memory address (block 820), as described in greater detail in conjunction with FIG. 8B below. The overall flow then ends (block 830).

FIG. 8B is an exemplary flow chart which in conjunction with FIG. 1 further illustrates the operations shown in FIG. 8A (block 820) to determine if the received virtualized memory address comprises predetermined unauthorized virtualized memory address. As shown in FIG. 8B, following the start of the process (block 850), it is determined if the received virtualized memory address is in a memory space available to a) the translation cache 104 (block 860), or b) to an interpret function 105 (block 870), or if c) the virtualized memory address is in a memory space region storing instructions or data for operations of the virtual machine 120 (block 880). If so, malicious code is deemed detected and the operation of the virtual machine 120 utilizing the received virtualized memory address is stopped, otherwise the address converter 106 converts the received virtualized memory address to a memory address meaningful to the host platform 110. The flow is then returned to block 820 of FIG. 8A (block 890).

In an exemplary embodiment of the invention, the software that, if executed by a computing device 100, will cause the computing device 100 to perform the above operations described in conjunction with FIGS. 2-8B is stored in a storage medium (not shown), such as main memory, or other storage devices such as a hard-disk.

It should be noted that the various features of the foregoing embodiments of the invention were discussed separately for clarity of description only and they can be incorporated in whole or in part into a single embodiment of the invention having all or some of these features.

What is claimed is:

1. A method comprising:
receiving in a virtual machine contents of a program for creating a virtual environment for interacting with a host platform in a computing device; and
determining by the virtual machine if the received contents comprises predetermined instructions for performing at least one unauthorized task.

2. The method of claim 1, wherein the determining if the received contents comprises predetermined instructions further comprises:
comparing the received contents of the program to at least one predetermined instruction patterns corresponding to the predetermined instructions for performing the at least one unauthorized task; and
purging the predetermined instructions from the received contents based on the comparing.

3. The method of claim 2, wherein the comparing the contents of the received program to at least one predetermined instruction patterns further comprises:
searching predetermined locations of the received contents of the program for the predetermined instructions.

4. The method of claim 2, wherein the virtual machine comprises a translation cache, wherein the contents of the program reside in the translation cache, and wherein determining if the received contents comprises predetermined instructions further comprises:
checking a branch target at the outlets of the translation cache; and
determining if the checked branch target comprises at least one of a translation cache and the execution engine.

5. The method of claim 4, further comprising:
generating checking and determining instructions for performing the checking the branch target and determining if the checked branch target comprises at least one of a translation cache and the execution engine.

6. The method of claim 2, wherein the virtual machine comprises an execution engine and at least one interpret function invoked by the execution engine, wherein the contents of the program reside in the at least one interpret function.

7. A system comprising:
a virtual machine to receive contents of a program for creating a virtual environment for interacting with a host platform in a computing device, the virtual machine comprising a detector subsystem to determine if the received contents comprises predetermined instructions for performing at least one unauthorized task.

8. The system of claim 7, wherein the detector subsystem is to purge the predetermined instructions from the received contents of the program, wherein the detector subsystem further comprises:
a comparator logic to compare the received contents of the program to at least one predetermined instruction patterns corresponding to the predetermined instructions for performing the at least one unauthorized task; and
a search logic to search predetermined locations of the received contents of the program for the predetermined instructions.

9. The system of claim 7, wherein the virtual machine comprises:
at least one of a translation cache to store translation data;
a translation engine to invoke the detector subsystem to determine if the contents of a translation data storage comprises predetermined instructions for performing at least one unauthorized task;
at least one loader, to receive contents of a program and to invoke the detector subsystem;
at least one interpreter function; and
an execution engine to invoke the detector subsystem to determine if the contents of the at least one interpret function invoked by the execution engine comprises predetermined instructions for performing at least one unauthorized task.

10. The system of claim 9, wherein the detector subsystem further comprises:
translation cache logic to check a branch target at the outlets of the translation cache and to determine if the checked branch target comprises at least one of a translation cache and the execution engine, based on translation cache logic instructions; and
an instruction generation subsystem to generate the translation cache logic instructions.

11. The method of claim 8, wherein the at least one predetermined instruction patterns are stored in a database in communication with the virtual machine.

12. A storage medium that provides software that, if executed by a computing device, will cause the computing device to perform the following operations:
receiving in a virtual machine contents of a program for creating a virtual environment for interacting with a host platform in a computing device; and
determining by the virtual machine if the received contents comprises predetermined instructions for performing at least one unauthorized task.

13. The storage medium of claim 12 further comprising software to:
compare the received contents of the program to at least one predetermined instruction patterns corresponding to the predetermined instructions for performing the at least one unauthorized task; and
purge the predetermined instructions from the received contents based on the comparing.

14. The storage medium of claim 13 further comprising software to:
search predetermined locations of the received contents of the program for the predetermined instructions

15. A method comprising:
receiving a system call for a host platform in communication with a virtual machine of a computing device; and
determining by the virtual machine if the received system call comprises at least one predetermined system call for performing at least one unauthorized task.

16. The method of claim 15, wherein the determining if the received system call comprises predetermined system call further comprises:
comparing the system call to at least one predetermined system call patterns corresponding to the predetermined system calls for performing the at least one unauthorized task.

17. The method of claim 16, wherein the unauthorized task comprises:
a task predetermined to be an inhibitive task by the computing device; and
a task to output data into memory regions storing at least one of instructions and data for operations of the virtual machine.

18. A method comprising:
receiving a virtualized memory address for a host platform in communication with a virtual machine of a computing device; and
determining by the virtual machine if the received virtualized memory address comprises at least one predetermined unauthorized virtualized memory address.

19. The method of claim 18, wherein the virtual machine further comprises:
at least one of a translation cache to store translation data;
an execution engine; and
at least one interpret function invoked by the execution engine.

20. The method of claim 19, wherein the determining by the virtual machine if the received virtualized memory address comprises at least one predetermined unauthorized virtualized memory address comprises:
determining if the virtualized memory address is in a memory space available to the translation cache;
determining if the virtualized memory address is in a memory space available to the at least one interpret function; and
determining if the virtualized memory address is in a memory space region storing at least one of instructions and data for operations of the virtual machine.
